(19) United States
(12) Patent Application Publication
(10) Pub. No.: US 2010/0117970 A1
(43) Pub. Date: May 13, 2010

(54) Methods of Operating Electronic Devices Using Touch Sensitive Interfaces with Contact and Proximity Detection and Related Devices and Computer Program Products

(75) Inventors: David Per Burstrom, Lund (SE); Anders Wilhelm Ostsjo, Bjarred (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/268,502

(22) Filed: Nov. 11, 2008

(51) Int. Cl. G06F 3/041

(52) U.S. Cl. 345/173

(57) ABSTRACT

A method of operating an electronic device using a touch sensitive user interface may include detecting contact between a first finger and the touch sensitive user interface, and detecting non-contact proximity of a second finger to the touch sensitive user interface. Responsive to detecting contact between the first finger and the touch sensitive user interface and responsive to detecting non-contact proximity of the second finger to the touch sensitive user interface, one of a plurality of operations may be selected. Responsive to selecting one of the plurality of operations, the selected operation may be performed. Related devices and computer program products are also discussed.

### FIELD OF THE INVENTION

This invention relates to user interfaces for electronic devices, and more particularly to touch panel interfaces for electronic devices such as wireless communication terminals and/or computer keyboards.

### BACKGROUND OF THE INVENTION

A touch sensitive user interface (also referred to as a touch sensitive panel), such as a touch sensitive screen or a touch sensitive pad, may be used to provide an interface(s) on an electronic device for a user to enter commands and/or data used in the operation of the device. Touch sensitive screens, for example, may be used in mobile radiotelephones, particularly cellular radiotelephones having integrated PDA (personal digital assistant) features and other phone operation related features. The touch sensitive screens are generally designed to operate and respond to a finger touch, a stylus touch, and/or finger/stylus movement on the touch screen surface. A touch sensitive screen may be used in addition to, in combination with, or in place of physical keys traditionally used in a cellular phone to carry out the phone functions and features. Touch sensitive pads may be provided below the spacebar of a keyboard of a computer (such as a laptop computer), and may be used to accept pointer and click inputs. In other words, a touch sensitive pad may be used to accept user input equivalent to input accepted by a computer mouse.

Touching a specific point on a touch sensitive screen may activate a virtual button, feature, or function found or shown at that location on the touch screen display. Typical phone features which may be operated by touching the touch screen display include entering a telephone number, for example, by touching virtual keys of a virtual keyboard shown on the display, making a call or ending a call, bringing up, adding to or editing and navigating through an address book, accepting inputs for internet browsing, and/or other phone functions such as text messaging, wireless connection to the global computer network, and/or other phone functions.

Commercial pressure to provide increased functionality is continuing to drive demand for even more versatile user interfaces.

### SUMMARY OF THE INVENTION

According to some embodiments of the present invention, a method of operating an electronic device using a touch sensitive user interface may include detecting contact between a first finger and the touch sensitive user interface, and detecting non-contact proximity of a second finger to the touch sensitive user interface. Responsive to detecting contact between the first finger and the touch sensitive user interface and responsive to detecting non-contact proximity of the second finger to the touch sensitive user interface, one of a plurality of operations may be selected. Responsive to selecting one of the plurality of operations, the selected operation may be performed. For example, the touch sensitive user interface may include a touch sensitive screen and/or a touch sensitive pad.

Detecting contact may include detecting contact between the first finger and the touch sensitive user interface using infrared (IR) contact sensing, acoustic wave contact sensing, capacitive contact sensing, and/or resistive contact sensing. Detecting non-contact proximity may include detecting non-contact proximity of the second finger to the touch sensitive user interface using optical sensing. For example, detecting contact may include detecting contact using a first sensing technology, and wherein detecting non-contact proximity comprises detecting non-contact proximity using a second sensing technology different than the first sensing technology. More particularly, the first sensing technology may be selected from infrared sensing, acoustic sensing, capacitive sensing, and/or resistive sensing, and the second sensing technology may be selected from acoustic sensing and/or optical sensing.

Detecting non-contact proximity may include detecting non-contact proximity of the second finger to the touch sensitive user interface without contact between the second finger and the touch sensitive user interface. Detecting non-contact proximity of the second finger may include detecting non-contact proximity of the second finger while detecting contact between the first finger and the touch sensitive user interface. Moreover, selecting one of a plurality of operations may include determining an orientation of the second finger relative to the first finger, selecting a first of the plurality of operations when the second finger is in a first orientation relative to the first finger, and selecting a second of the plurality of operations when the second finger is in a second orientation relative to the first finger different than the first orientation. The first operation may include initiating a link to a website identified by detecting contact between the first finger and the touch sensitive user interface, and the second operation may include an editing operation and/or a bookmarking operation.

In addition, non-contact proximity of a third finger to the touch sensitive user interface may be detected. Accordingly, selecting one of the plurality of operations may include selecting a first of the plurality of operations when the first finger is between the second and third fingers, and selecting a second of the plurality of operations when the second and third fingers are on a same side of the first finger.

According to other embodiments of the present invention, an electronic device may include a touch sensitive user interface with a contact detector and a non-contact proximity detector. The contact detector may be configured to detect contact between a first finger and the touch sensitive user interface, and the non-contact proximity detector may be configured to detect a proximity of a second finger to the touch sensitive user interface. In addition, a controller may be coupled to the touch sensitive user interface. The controller may be configured to select one of a plurality of operations responsive to detecting contact between the first finger and the touch sensitive user interface and responsive to detecting non-contact proximity of the second finger to the touch sensitive user interface. In addition, the controller may be configured to perform the selected operation responsive to selecting one of the plurality of operations. For example, the touch sensitive user interface may include a touch sensitive screen and/or a touch sensitive pad.

The contact detector may be configured to detect contact between the first finger and the touch sensitive user interface using infrared (IR) contact sensing, acoustic wave contact sensing, capacitive contact sensing, and/or resistive contact sensing. The non-contact proximity detector may be configured to detect non-contact proximity of the second finger to the touch sensitive user interface using optical sensing. For example, the contact detector may be configured to detect contact using a first sensing technology, and the non-contact proximity detector may be configured to detect non-contact proximity using a second sensing technology different than the first sensing technology. More particularly, the first sensing technology may be selected from infrared sensing, acoustic sensing, capacitive sensing, and/or resistive sensing, and the second sensing technology is selected from acoustic sensing and/or optical sensing.

The non-contact proximity detector may be configured to detect non-contact proximity of the second finger to the touch sensitive user interface without contact between the second finger and the touch sensitive user interface. The non-contact proximity detector may be configured to detect non-contact proximity of the second finger while detecting contact between the first finger and the touch sensitive user interface. The controller may be configured to select one of the plurality of operations by determining an orientation of the second finger relative to the first finger, selecting a first of the plurality of operations when the second finger is in a first orientation relative to the first finger, and selecting a second of the plurality of operations when the second finger is in a second orientation relative to the first finger different than the first orientation. For example, the first operation may include initiating a link to a website identified by detecting contact between the first finger and the touch sensitive user interface, and the second operation may include an editing operation and/or a bookmarking operation.

The non-contact proximity detector may be further configured to detect non-contact proximity of a third finger to the touch sensitive user interface, and the controller may be configured to select a first of the plurality of operations when the first finger is between the second and third fingers, and to select a second of the plurality of operations when the second and third fingers are on a same side of the first finger.

According to still other embodiments of the present invention, a computer program product may be provided to operate an electronic device using a touch sensitive user interface, and the computer program product may include a computer readable storage medium having computer readable program code embodied therein. The computer readable program code may include computer readable program code configured to detect contact between a first finger and the touch sensitive user interface, and computer readable program code configured to detect non-contact proximity of a second finger to the touch sensitive user interface. The computer readable program code may further include computer readable program code configured to select one of a plurality of operations responsive to detecting contact between the first finger and the touch sensitive user interface and responsive to detecting non-contact proximity of the second finger to the touch sensitive user interface. In addition, the computer readable program code may include computer readable program code configured to perform the selected operation responsive to selecting one of the plurality of operations.

### BRIEF DESCRIPTION OF THE DRAWINGS

FIG. 1 is a block diagram of an electronic device including a touch sensitive user interface according to some embodiments of the present invention.

FIG. 2 is a block diagram of an electronic device including a touch sensitive user interface according to some other embodiments of the present invention.

FIGS. 3A and 3B are schematic illustrations of a touch sensitive user interface according to some embodiments of the present invention.

FIG. 4 is a flow chart illustrating operations of an electronic device including a touch sensitive interface according to some embodiments of the present invention.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, electronic devices, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments are described below with reference to block diagrams and operational flow charts. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Although various embodiments of the present invention are described in the context of wireless communication terminals for purposes of illustration and explanation only, the present invention is not limited thereto. It is to be understood that the present invention can be more broadly used in any sort of electronic device to identify and respond to input on a touch sensitive user input.

It will be understood that, although the terms first, second, third etc. may be used herein to describe various elements, components, and/or sections, these elements, components, and/or sections should not be limited by these terms. These terms are only used to distinguish one element, component, or section from another element, component, or section. Thus, a first element, component, or section discussed below could be termed a second element, component, or section without departing from the teachings of the present invention.

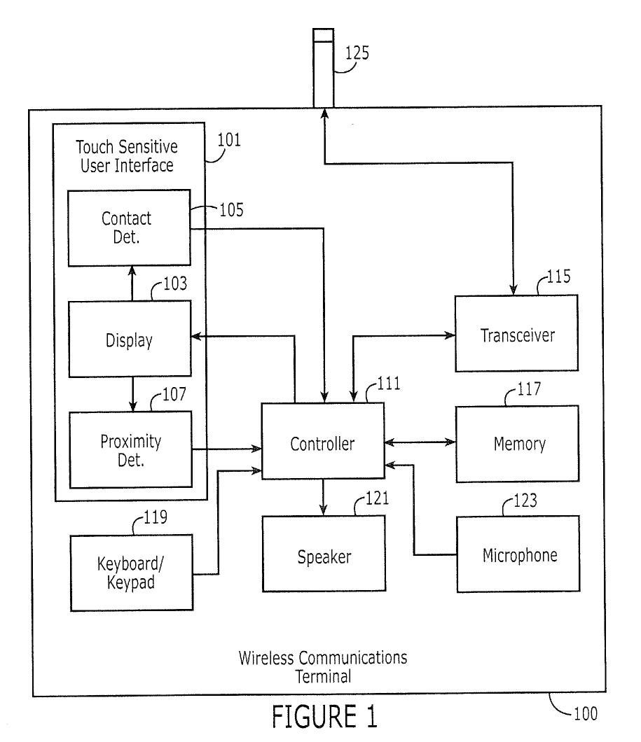

FIG. 1 is a block diagram of an electronic device 100 (such as a cellular radiotelephone) including a touch sensitive user interface 101 according to some embodiments of the present invention. The electronic device 100, for example, may be a wireless communications device (such as a cellular radiotelephone), a PDA, an audio/picture/video player/recorder, a global positioning (GPS) unit, a gaming device, or any other electronic device including a touch sensitive screen display. Electronic device 100 may also include a controller 111 coupled to touch sensitive user interface 101, a radio transceiver 115 coupled to controller 111, and a memory 117 coupled to controller 111. In addition, a keyboard/keypad 119, a speaker 121, and/or a microphone 123 may be coupled to controller 111. As discussed herein, electronic device 100 may be a cellular radiotelephone configured to provide PDA functionality, data network connectivity (such as Internet browsing), and/or other data functionality.

The controller 111 may be configured to communicate through transceiver 115 and antenna 125 over a wireless air interface with one or more RF transceiver base stations and/or other wireless communication devices using one or more wireless communication protocols such as, for example, Global Standard for Mobile (GSM) communication, General Packet Radio Service (GPRS), enhanced data rates for GSM evolution (EDGE), Integrated Digital Enhancement Network (iDEN), code division multiple access (CDMA), wideband-CDMA, CDMA2000, Universal Mobile Telecommunications System (UMTS), WiMAX, and/or HIPERMAN, wireless local area network (e.g., 802.11), and/or Bluetooth. Controller 111 may be configured to carry out wireless communications functionality, such as conventional cellular phone functionality including, but not limited to, voice/video telephone calls and/or data messaging such as text/picture/video messaging.

The controller 111 may be further configured to provide various user applications which can include a music/picture/video recorder/player application, an e-mail/messaging application, a calendar/appointment application, and/or other user applications. The audio/picture/video recorder/player application can be configured to record and playback audio, digital pictures, and/or video that are captured by a sensor (e.g., microphone 123 and/or a camera) within electronic device 100, downloaded into electronic device 100 via radio transceiver 115 and controller 111, downloaded into electronic device 100 via a wired connection (e.g., via USB), and/or installed within electronic device 100 such as through a removable memory media. An e-mail/messaging application may be configured to allow a user to generate e-mail/messages (e.g., short messaging services messages and/or instant messages) for transmission via controller 111 and transceiver 115. A calendar/appointment application may provide a calendar and task schedule that can be viewed and edited by a user to schedule appointments and other tasks.

More particularly, touch sensitive user interface 101 may be a touch sensitive screen including a display 103, a contact detector 105, and a proximity detector 107. For example, contact detector 105 may be configured to detect contact between a first finger and display 103, and proximity detector 107 may be configured to detect proximity of a second finger to display 103 without contact between the second finger and touch sensitive user interface 101. More particularly, contact detector 105 may be configured to detect contact between first finger and touch sensitive user interface 101 using infrared (IR) contact sensing, acoustic wave contact sensing, capacitive contact sensing, and/or resistive contact sensing. Proximity detector 107 may be configured to detect proximity of the second finger to touch sensitive user interface 101 using acoustic sensing and/or optical sensing. Optical sensing may be provided, for example, using a High Ambient Light Independent Optical System (HALIOS®) as discussed in the reference by Rottmann et al. in “Electronic Concept Fulfils Optical Sensor Dream” published by ELMOS Semiconductor AG at http://www.mechaless.com/images/pdf/Elektronikartikel_ENG.pdf. The disclosure of the Rottmann et al. reference is hereby incorporated herein in its entirety by reference. Optical sensing is also discussed in the reference entitled “HALIOS®—Optics For Human Machine Interfaces,” ELMOS Semiconductor AC, Version 1.0, pages 1-15, Mar. 3, 2008, the disclosure of which is also incorporated herein in its entirety by reference.

Accordingly, contact detector 105 may be configured to detect contact using a first sensing technology, and proximity detector 107 may be configured to detect non-contact proximity using a second technology different than the first technology. More particularly, proximity detector 107 may be configured to detect non-contact proximity while the contact detector 105 is detecting contact. For example, contact detector 105 may be configured to detect contact using a first sensing technology such as infrared sensing, acoustic wave sensing, capacitive sensing, and/or resistive sensing, and proximity detector 107 may be configured to detect non-contact proximity using a second sensing technology such as acoustic sensing and/or optical sensing. According to other embodiments of the present invention, a same technology (such as an optical sensing technology) may provide both contact and non-contact proximity sensing so that contact detector 105 and proximity detector 107 may be implemented using a single detector.

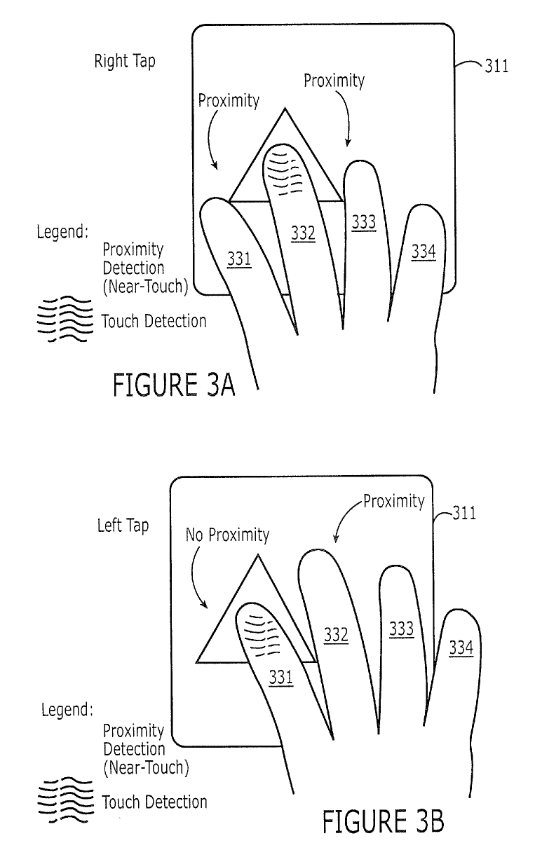

Accordingly, controller 111 may be configured to select one of a plurality of different operations responsive to detecting contact between a first finger and touch sensitive user interface 101 and responsive to detecting non-contact proximity of a second finger to touch sensitive user interface 101, and then perform the selected operation. As discussed in greater detail below with respect to FIGS. 3A and 3B, by detecting contact of a first finger and non-contact proximity of a second finger relative to display 103 of touch sensitive user interface 101 at the same time, controller 111 may determine which finger (e.g., pointer finger, middle finger, etc.) is in contact with display 103. Accordingly, different operations may be performed depending on the finger making contact with display 103.

For example, a web address may be shown on display 103, and contact with the portion of display 103 where the web address is shown may select the web address. Once the web address has been selected, however, one of a plurality of operations relating to the web address may be performed depending on an orientation of a proximate finger relative to the contacting finger. With a right handed user, for example, if the pointer finger is the contacting finger, there will be no proximate finger to the left of the contacting finger, and if the middle finger is the contacting finger, there will be a proximate non-contacting finger (i.e., the pointer finger) to the left of the contacting finger. If the contacting finger is the pointer finger, for example, a communications link may be established with a website identified by the selected web address, and if the contacting finger is the middle finger, another operation (such as a bookmarking operation and/or an editing operation) may be performed using the selected web address.

According to other embodiments of the present invention, a contact alias may be shown on display 103. If pointer finger contact is made with the contact alias, a communication (e.g., a telephone call, an e-mail, a text message, etc.) with the contact may be initiated, while if middle finger contact is made with the contact alias, a property(ies) (e.g., telephone number, e-mail address, text message address, etc.) may be shown, and/or an editing operation may be initiated. While differentiation between two fingers is discussed by way of example, differentiation between three or more fingers may be provided as discussed in greater detail below.

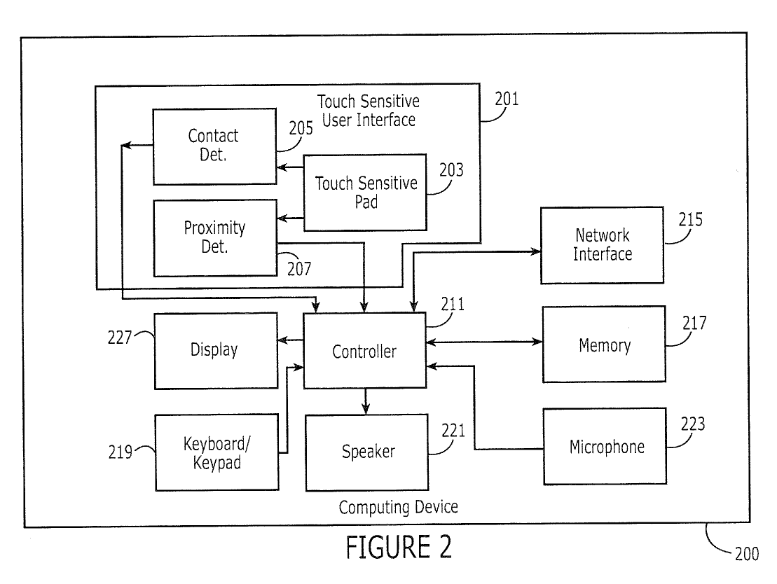

FIG. 2 is a block diagram of an electronic device 200 including a touch sensitive user interface 201 according to some embodiments of the present invention. The electronic device 200 may be a computing device (such as a laptop computer) including a touch sensitive pad. Device 200 may also include a controller 211 coupled to touch sensitive user interface 201, a network interface 215 coupled to controller 211, and a memory 217 coupled to controller 211. In addition, a display 227, a keyboard/keypad 219, a speaker 221, and/or a microphone 223 may be coupled to controller 211. As discussed herein, device 200 may be a laptop computer configured to provide data network connectivity (such as Internet browsing), and/or other data functionality. Moreover, touch sensitive pad 203 may be provided below a spacebar of keyboard 219 to accept user input of pointer and/or click commands similar to pointer and click commands normally accepted though a computer mouse.

The controller 211 may be configured to communicate through network interface 215 with one or more other remote devices over a local area network, a wide area network, and/or the Internet. Controller 211 may be further configured to provide various user applications which can include an audio/picture/video recorder/player application, an e-mail/messaging application, a calendar/appointment application, and/or other user applications. The audio/picture/video recorder/player application can be configured to record and playback audio, digital pictures, and/or video that are captured by a sensor (e.g., microphone 223 and/or a camera) within device 200, downloaded into device 200 via network interface 215 and controller 211, downloaded into device 200 via a wired connection (e.g., via USB), and/or installed within device 200 such as through a removable memory media. An e-mail/messaging application may be configured to allow a user to generate e-mail/messages for transmission via controller 211 and network interface 215. A calendar/appointment application may provide a calendar and task schedule that can be viewed and edited by a user to schedule appointments and other tasks.

More particularly, touch sensitive user interface 201 may include a touch sensitive pad 203, a contact detector 205, and a non-contact proximity detector 207. For example, contact detector 205 may be configured to detect contact between a first finger and pad 203, and non-contact proximity detector 207 may be configured to detect non-contact proximity of a second finger to pad 203 without contact between the second finger and the touch sensitive user interface. More particularly, contact detector 205 may be configured to detect contact between the first finger and pad 203 using infrared (IR) contact sensing, acoustic wave contact sensing, capacitive contact sensing, and/or resistive contact sensing. Non-contact proximity detector 207 may be configured to detect non-contact proximity of the second finger to pad 203 using acoustic sensing and/or optical sensing. Optical sensing may be provided, for example, using a High Ambient Light Independent Optical System (HALIOS) as discussed in the reference by Rottmann et al. in “Electronic Concept Fulfils Optical Sensor Dream” published by ELMOS Semiconductor AG at http://www.mechaless.com/images/pdf/Elektronikartikel_ENG.pdf. The disclosure of the Rottmann et al. reference is hereby incorporated herein in its entirety by reference. Optical sensing is also discussed in the reference entitled “HALIOS®—Optics For Human Machine Interfaces,” ELMOS Semiconductor AG, Version 1.0, pages 1-15, Mar. 3, 2008, the disclosure of which is also incorporated herein in its entirety by reference.

Accordingly, contact detector 205 may be configured to detect contact using a first sensing technology, and non-contact proximity detector 207 may be configured to detect non-contact proximity using a second technology different than the first technology. More particularly, non-contact proximity detector 207 may be configured to detect non-contact proximity while the contact detector 205 is detecting contact. For example, contact detector 205 may be configured to detect contact using a first sensing technology such as infrared sensing, acoustic wave sensing, capacitive sensing, and/or resistive sensing, and non-contact proximity detector 207 may be configured to detect non-contact proximity using a second sensing technology such as acoustic sensing and/or optical sensing. According to other embodiments of the present invention, a same technology (such as an optical sensing technology) may provide both contact and non-contact proximity sensing so that contact detector 205 and non-contact proximity detector 207 may be implemented using a single detector.

Accordingly, controller 211 may be configured to select one of a plurality of different operations responsive to detecting contact between a first finger and touch sensitive user interface 201 and responsive to detecting non-contact proximity of a second finger to touch sensitive user interface 201, and then perform the selected operation. As discussed in greater detail below with respect to FIGS. 3A and 3B, by detecting contact of a first finger and non-contact proximity of a second finger relative to pad 203 of touch sensitive user interface 201 at the same time, controller 211 may determine which finger (e.g., pointer finger, middle finger, etc.) is in contact with pad 203. Accordingly, different operations may be performed depending on the finger making contact with pad 203.

For example, touch sensitive user interface 201 may be configured to differentiate between three different fingers (e.g., pointer, middle, and ring fingers) to provide three different command types. With a right handed user, for example, there will be no proximate finger to the left of the contacting finger if the pointer finger is the contacting finger, there will be one non-contacting proximate finger (i.e., the pointer finger) to the left of the contacting finger if the middle finger is the contacting finger, and there will be two non-contacting proximate fingers (i.e., the pointer and middle fingers) to the left of the contacting finger if the ring finger is the contacting finger. To emulate functionality of a computer mouse (without requiring separate click buttons), for example, movement of a pointer finger in contact with pad 203 may be interpreted as a pointer command to move a pointer on display 227; contact of a middle finger with pad 203 may be interpreted as a left mouse click operation; and contact of a ring finger with pad 203 may be interpreted as a right mouse click operation. While differentiation between three fingers is discussed by way of example, differentiation between two or four fingers may be provided as discussed in greater detail below.

FIGS. 3A and 3B are schematic illustrations showing operations of a touch sensitive user interface 311 according to some embodiments of the present invention. The operations shown in FIGS. 3A and 3B may be applied to touch sensitive user interface 101 (implemented with touch sensitive screen display 103) of FIG. 1 or to touch sensitive user interface 201 (implemented with touch sensitive pad 203) of FIG. 2. Accordingly, the touch sensitive user interface 311 may be a touch sensitive screen display or a touch sensitive pad. In the example of FIGS. 3A and 3B, the touch sensitive user interface 311 may be configured to differentiate between contact from a pointer finger 331 and a middle finger 332 for right hand use.

As shown in FIG. 3A, middle finger 332 may contact interface 331 while pointer finger 331, ring finger 333, and pinky finger 334 are proximate to interface 331 without contacting interface 331. By detecting proximity of one non-contacting finger (i.e., pointer finger 331) to the left of the contacting finger (i.e., middle finger 332), a determination can be made that the contacting finger is middle finger 332, and an appropriate operation corresponding to a middle finger contact may be initiated. In addition, or in an alternative, a determination can be made that the contacting finger is middle finger 332 by detecting proximity of two non-contacting fingers (i.e., ring and pinky fingers 333 and 334) to the right of the contacting finger (i.e., middle finger 332).

As shown in FIG. 3B, pointer finger 331 may contact interface 331 while middle finger 332, ring finger 333, and pinky finger 334 are proximate to interface 331 without contacting interface 331. By detecting a lack of proximity of any fingers to the left of the contacting finger (i.e., pointer finger 331), a determination can be made that the contacting finger is pointer finger 331, and an appropriate operation corresponding to pointer finger contact may be initiated (different than the operation corresponding to middle finger contact). In addition, or in an alternative, a determination can be made that the contacting finger is pointer finger 331 by detecting proximity of three non-contacting fingers (i.e., middle, ring, and pinky fingers 332, 333, and 334) to the right of the contacting finger (i.e., pointer finger 332).

Moreover, different operations may be assigned to each of the four fingers, and detection operations may be used to determine which of the four fingers is contacting interface 311. Contact by ring finger 333, for example, may be determined by detecting proximity of two non-contacting fingers (i.e., pointer and middle fingers 331 and 332) to the left of the contacting finger (i.e., ring finger 333), and/or by detecting proximity only one non-contacting finger (i.e., pinky finger 334) to the right of contacting finger (i.e., ring finger 333). Contact by pinky finger 334 may be determined by detecting proximity of three non-contacting fingers (i.e., pointer finger 331, middle finger 332, and ring finger 333) to the right of contacting finger (i.e., pinky finger 334), and/or by detecting proximity of no fingers to the right of the contacting finger (i.e., pinky finger 334).

Alternate detection criteria (e.g., considering non-contacting proximate fingers to the left and right of the contacting finger) may be used to provide redundancy in the determination and/or to accommodate a situation where the contacting finger is near an edge of interface 311 so that proximate non-contacting fingers on one side of the contacting finger are not within range of detection. Moreover, the examples discussed above are discussed for right hand use. Left hand use, however, may be provided by using a reversed consideration of fingers proximate to the contacting finger. In addition, an electronic device 100/200 incorporating touch sensitive user interface 311/101/201 may provide user selection of right or left hand use. For example, a set-up routine of the electronic device 100/200 may prompt the user to enter a right hand or left hand preference, and the preference may be stored in memory 117/217 of the electronic device 100/200. The controller 111/211 of the electronic device 100/200 may use the stored preference to determine how to interpret finger contact with interface 311/101/201.

According to other embodiments of the present invention, operations may be restricted to use of two fingers (e.g., pointer and middle fingers), and determination of the contacting finger may be performed automatically without requiring prior selection/assumption regarding right or left handed use. Stated in other words, touch sensitive user interface 311/101/201 may be configured to differentiate between pointer and middle fingers to provide two different command types responsive to contact with touch sensitive user interface 311/101/201. By way of example, if the pointer finger is the contacting finger, there will be no non-contacting proximate fingers on one side of the contacting finger regardless of light or left handed use. If the middle finger is the contacting finger, there will be non-contacting proximate fingers on both sides of the contacting finger regardless of right or left handed use. Accordingly, determination of pointer or middle finger contact may be performed regardless of right or left handedness and/or regardless of user orientation relative to touch sensitive user interface 311/101/201. For example, determination of pointer or middle finger contact may be performed if the user is oriented normally with respect to touch sensitive user interface 311/101/201 (e.g., with the wrist/arm below the touch sensitive user interface), if the user is oriented sideways with respect to touch sensitive user interface 311/101/201 (e.g., with the wrist/arm to the side of touch sensitive user interface), or if the user is oriented upside down with respect to touch sensitive user interface 311/101/201 (e.g., with the wrist/arm above the touch sensitive user interface).

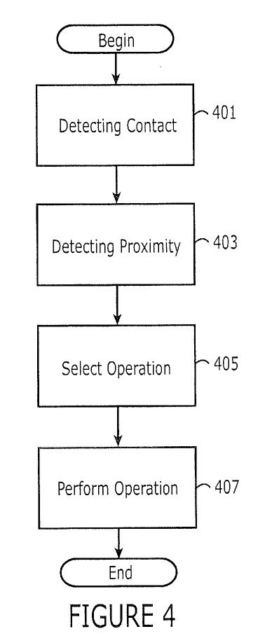

FIG. 4 is a flow chart illustrating operations of an electronic device including a touch sensitive interface according to some embodiments of the present invention. Operations of FIG. 4 may be performed, for example, by an electronic device including a touch sensitive screen display as discussed above with respect to FIG. 1, or by an electronic device including a touch sensitive pad as discussed above with respect to FIG. 2. At block 401, contact between a first finger and the touch sensitive user interface may be detected, for example, using infrared (IR) contact sensing, acoustic wave contact sensing, capacitive contact sensing, and/or resistive contact sensing. At block 403, non-contact proximity of a second finger to the touch sensitive user interface may be detected, for example, using optical sensing. More particularly, non-contact proximity of the second finger may be detected at block 403 while detecting contact of the first finger at block 401, and/or contact of the first finger and non-contact proximity of the second finger may be detected at the same time.

Responsive to detecting contact between the first finger and the touch sensitive user interface and responsive to detecting non-contact proximity of the second finger to the touch sensitive user interface, one of a plurality of operations may be selected at block 405. For example, the selection may be based on a determination of relative orientations of the first and second fingers as discussed above with respect to FIGS. 3A and 3B. More particularly, the selection may be based on a determination of which finger (i.e., pointer, middle, ring, or pinky) is the contacting finger, and different operations may be assigned to at least two of the fingers. Responsive to selecting one of the plurality of operations, the selected operation may be performed at block 407.

Computer program code for carrying out operations of devices and/or systems discussed above may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Some embodiments of the present invention have been described above with reference to flowchart and/or block diagram illustrations of methods, mobile terminals, electronic devices, data processing systems, and/or computer program products. These flowchart and/or block diagrams further illustrate exemplary operations of processing user input in accordance with various embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

In the drawings and specification, there have been disclosed examples of embodiments of the invention and, although specific terms are employed, they are used in a generic and descriptive sense only and not for purposes of limitation, the scope of the invention being set forth in the following claims.

That which is claimed is:

1. A method of operating an electronic device using a touch sensitive user interface, the method comprising:
detecting contact between a first finger and the touch sensitive user interface;
detecting non-contact proximity of a second finger to the touch sensitive user interface;
responsive to detecting contact between the first finger and the touch sensitive user interface and responsive to detecting non-contact proximity of the second finger to the touch sensitive user interface, selecting one of a plurality of operations; and
responsive to selecting one of the plurality of operations, performing the selected operation.

2. A method according to claim 1 wherein detecting contact comprises detecting contact between the first finger and the touch sensitive user interface using infrared (IR) contact sensing, acoustic wave contact sensing, capacitive contact sensing, and/or resistive contact sensing.

3. A method according to claim 1 wherein detecting non-contact proximity comprises detecting non-contact proximity of the second finger to the touch sensitive user interface using optical sensing.

4. A method according to claim 1 wherein detecting contact comprises detecting contact using a first sensing technology, and wherein detecting non-contact proximity comprises detecting non-contact proximity using a second sensing technology different than the first sensing technology.

5. A method according to claim 4 wherein the first sensing technology is selected from infrared sensing, acoustic sensing, capacitive sensing, and/or resistive sensing, and wherein the second sensing technology is selected from acoustic sensing and/or optical sensing.

6. A method according to claim 1 wherein detecting non-contact proximity of the second finger comprises detecting non-contact proximity of the second finger while detecting contact between the first finger and the touch sensitive user interface.

7. A method according to claim 1, wherein selecting one of a plurality of operations comprises,
determining an orientation of the second finger relative to the first finger,
when the second finger is in a first orientation relative to the first finger, selecting a first of the plurality of operations, and
when the second finger is in a second orientation relative to the first finger different than the first orientation, selecting a second of the plurality of operations.

8. A method according to claim 7 wherein the first operation comprises initiating a link to a website identified by detecting contact between the first finger and the touch sensitive user interface, and wherein the second operation comprises an editing operation and/or a bookmarking operation.

9. A method according to claim 1 further comprising:
detecting non-contact proximity of a third finger to the touch sensitive user interface;
wherein selecting one of the plurality of operations comprises selecting a first of the plurality of operations when the first finger is between the second and third fingers, and selecting a second of the plurality of operations when the second and third fingers are on a same side of the first finger.

10. A method according to claim 1 wherein the touch sensitive user interface comprises a touch sensitive screen and/or a touch sensitive pad.

11. An electronic device comprising:
a touch sensitive user interface including a contact detector configured to detect contact between a first finger and the touch sensitive user interface, and a proximity detector configured to detect non-contact proximity of a second finger to the touch sensitive user interface; and
a controller coupled to the touch sensitive user interface, wherein the controller is configured to select one of a plurality of operations responsive to detecting contact between the first finger and the touch sensitive user interface and responsive to detecting non-contact proximity of the second finger to the touch sensitive user interface, and to perform the selected operation responsive to selecting one of the plurality of operations.

12. An electronic device according to claim 11 wherein the contact detector is configured to detect contact between the first finger and the touch sensitive user interface using infrared (IR) contact sensing, acoustic wave contact sensing, capacitive contact sensing, and/or resistive contact sensing.

13. An electronic device according to claim 11 wherein the proximity detector is configured to detect non-contact proximity of the second finger to the touch sensitive user interface using optical sensing.

14. An electronic device according to claim 11 wherein the contact detector is configured to detect contact using a first sensing technology, and wherein the proximity detector is configured to detect non-contact proximity using a second sensing technology different than the first sensing technology.

15. An electronic device according to claim 14 wherein the first sensing technology is selected from infrared sensing, acoustic sensing, capacitive sensing, and/or resistive sensing, and wherein the second sensing technology is selected from acoustic sensing and/or optical sensing.

16. An electronic device according to claim 11 wherein detecting non-contact proximity of the second finger comprises detecting non-contact proximity of the second finger while detecting contact between the first finger and the touch sensitive user interface.

17. An electronic device according to claim 11, wherein the controller is configured to select one of the plurality of operations by determining an orientation of the second finger relative to the first finger, selecting a first of the plurality of operations when the second finger is in a first orientation relative to the first finger, and selecting a second of the plurality of operations when the second finger is in a second orientation relative to the first finger different than the first orientation.

18. An electronic device according to claim 17 wherein the first operation comprises initiating a link to a website identified by detecting contact between the first finger and the touch sensitive user interface, and wherein the second operation comprises an editing operation and/or a bookmarking operation.

19. An electronic device according to claim 11 wherein the proximity detector is further configured to detect non-contact proximity of a third finger to the touch sensitive user interface, and wherein the controller is configured to select a first of the plurality of operations when the first finger is between the second and third fingers, and to select a second of the plurality of operations when the second and third fingers are on a same side of the first finger.

20. An electronic device according to claim 11 wherein the touch sensitive user interface comprises a touch sensitive screen and/or a touch sensitive pad.
